(19) United States
(12) Patent Application Publication
(10) Pub. No.: US 2026/0312160 A1
(43) Pub. Date: Oct. 8, 2026

(54) BATTERY PACK

(71) Applicant: TOYOTA JIDOSHA KABUSHIKI KAISHA, Toyota-shi (JP)

(72) Inventors: Amane SHIMURA, Anjo-shi (JP); Makoto HIDAKA, Seto-shi (JP); Kaname HATANO, Toyota-shi (JP)

(73) Assignee: TOYOTA JIDOSHA KABUSHIKI KAISHA, Toyota-shi (JP)

(21) Appl. No.: 19/637,629

(22) Filed: Apr. 2, 2026

(30) Foreign Application Priority Data
Apr. 7, 2025 (JP) 2025-063158

(51) Int. Cl. H01M 10/48; G01K 13/00; H01M 50/24; H01M 50/249; H01M 50/271

(52) U.S. Cl. CPC H01M 10/486; G01K 13/00; H01M 10/482; H01M 50/24; H01M 50/249; H01M 50/271; H01M 2220/20

(57) ABSTRACT

A battery pack includes: a battery case including an upper case and a lower case; a secondary battery housed in the battery case; a sealing material disposed between a peripheral portion of the upper case and a peripheral portion of the lower case; a case joint portion where the peripheral portion of the upper case and the peripheral portion of the lower case are joined via the sealing material; and a temperature sensor positioned adjacent to the case joint and in contact with an inner surface of the battery case.

The present application claims priority to and incorporates by reference the entire contents of Japanese Patent Application No. 2025-063158 filed in Japan on April 7, 2025.

### BACKGROUND

The present disclosure relates to a battery pack.

JP2024060207A discloses a battery pack having a case joint where the peripheral portion of an upper case and the peripheral portion of a lower case, which constitute a battery case housing a secondary battery, are joined via a sealing material.

### SUMMARY

It is desirable to estimate the temperature of the sealing material provided at the case joint of the battery case to suppress its degradation due to excessive heating from a heat source. However, directly providing a temperature sensor on the sealing material risks impairing its sealing function.

There is a need for a battery pack that can estimate the temperature of the sealing material without impairing its sealing function.

According to one aspect of the present disclosure, there is provided a battery pack including: a battery case including an upper case and a lower case; a secondary battery housed in the battery case; a sealing material disposed between a peripheral portion of the upper case and a peripheral portion of the lower case; a case joint portion where the peripheral portion of the upper case and the peripheral portion of the lower case are joined via the sealing material; and a temperature sensor positioned adjacent to the case joint and in contact with an inner surface of the battery case.

### BRIEF DESCRIPTION OF THE DRAWINGS

FIG. 1 is a cross-sectional view showing a schematic configuration of the battery pack according to an embodiment as viewed from the side; and

FIG. 2 is a flowchart showing an example of overheating suppression control for the sealing material in the battery pack according to the embodiment.

### DETAILED DESCRIPTION

The following describes an embodiment of a battery pack according to the present disclosure. It should be noted that the present disclosure is not limited to this embodiment.

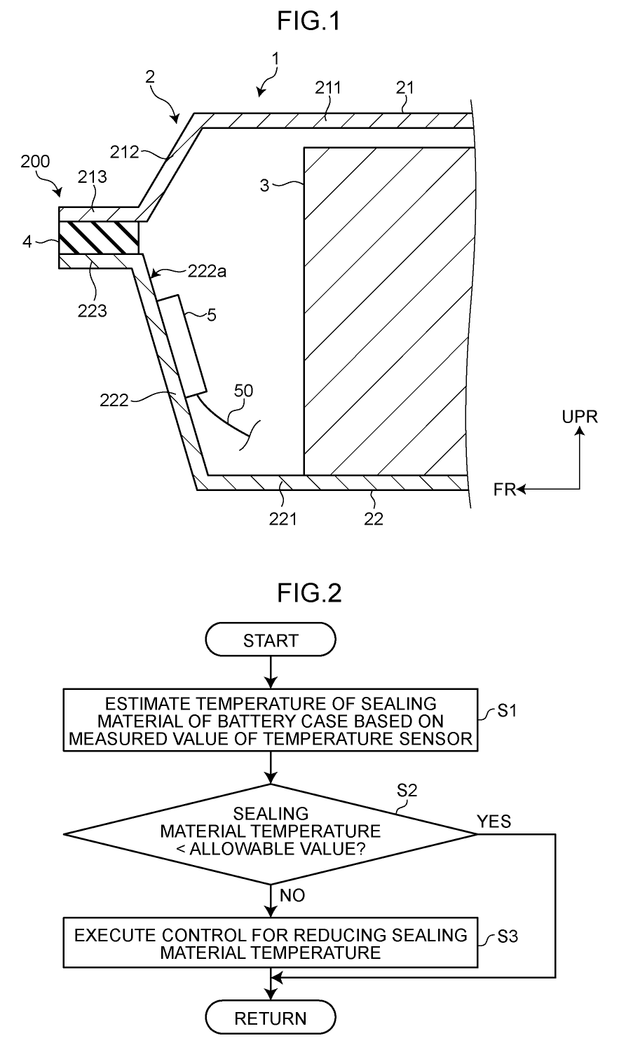

FIG. 1 is a cross-sectional view showing a schematic configuration of the battery pack 1 according to the embodiment as viewed from the side. The battery pack 1 according to the embodiment is configured by housing a battery assembly 3 within a battery case 2, which is composed of an upper case 21 and a lower case 22. The battery assembly 3 is configured, for example, by stacking multiple battery cells. The battery cells are, for example, rechargeable secondary batteries such as lithium-ion batteries. The battery pack 1 according to the embodiment is mounted, for example, in a vehicle equipped with an engine and a motor, such as a PHEV.

In this embodiment, the longitudinal direction of the battery pack 1 is also simply referred to as the “longitudinal direction”. In this embodiment, the height direction perpendicular to the longitudinal direction of the battery pack 1 is also simply referred to as the “height direction.” Furthermore, in this embodiment, the longitudinal direction of the battery pack 1 is the same as the longitudinal direction of the battery case 2 and the battery pack assembly 3, and the height direction of the battery pack 1 is the same as the height direction of the battery case 2 and the battery pack assembly 3. Furthermore, “FR” in FIG. 1 indicates the longitudinal direction, representing the front side in the vehicle's fore-aft direction. “UPR” in FIG. 1 indicates the height direction, representing the upper side in the vehicle's height direction.

The upper case 21 of the battery case 2 comprises a top plate portion 211, a side plate portion 212, and a flange portion 213, forming a box-like shape open downward. The upper case 21 is composed of a metal material, such as iron or aluminum. The top plate portion 211 of the upper case 21 is formed, for example, as a flat plate and is positioned above the battery assembly 3. The side plate portion 212 of the upper case 21 extends downward from the periphery of the top plate portion 211 and surrounds the assembled battery 3. The flange portion 213 of the upper case 21 is the peripheral portion of the upper case 21 and has a shape that projects outward in the longitudinal direction from the lower end of the side plate portion 212.

The lower case 22 of the battery case 2 comprises a bottom plate portion 221, a side plate portion 222, and a flange portion 223, forming a box-shaped structure open at the top. The lower case 22 is made of a metal material such as iron or aluminum. The bottom plate portion 221 is positioned below the assembled battery 3. The side plate portion 222 of the lower case 22 rises from the periphery of the bottom plate portion 221 and surrounds the assembled battery 3. The flange portion 223 of the lower case 22 is the peripheral portion of the lower case 22 and has a shape that projects outward in the longitudinal direction from the upper end of the side plate portion 222.

The flange portion 213 of the upper case 21 and the flange portion 223 of the lower case 22 face each other in the height direction. In the battery case 2, the case joint portion 200 is formed by joining the flange portion 213 of the upper case 21 and the flange portion 223 of the lower case 22. At the case joint portion 200, a sealing material 4 is disposed between the flange portion 213 of the upper case 21 and the flange portion 223 of the lower case 22 to fill the gap between the flange portion 213 and the flange portion 223. The sealing material 4 is, for example, composed of a resin material.

Furthermore, a temperature sensor 5, used to estimate (measure) the temperature of the sealing material 4, is placed in contact with the inner surface 222a of the side plate portion 222 of the lower case 22, adjacent to the case joint portion 200. The temperature sensor 5 is connected to a control device via wiring 50, etc. A signal corresponding to the measured value detected by the temperature sensor 5 is output to the control device via wiring 50, etc. The control device then functions as estimation means to estimate the temperature of the sealing material 4 based on the measured value from the temperature sensor 5. The control device may, for example, be a shared ECU installed in the vehicle and capable of performing drive control of components such as the engine.

Furthermore, when the estimated temperature of the sealing material 4 exceeds a preset allowable value, the control device implements control capable of reducing the temperature of the sealing material 4, thereby suppressing the sealing material 4 from becoming excessively hot (overheating). For example, when the vehicle equipped with the battery pack 1 is a PHEV, it is preferable to position the temperature sensor 5 on the inner surface 222a of the side plate portion 222 of the lower case 22, specifically near the exhaust pipe connected to the engine. This allows overheating of the sealing material 4 to be suppressed by performing overheating suppression control, such as reducing engine output, when the temperature of the sealing material 4, heated by heat flow from sources like the exhaust pipe and engine compartment, exceeds the allowable value.

In the battery pack 1 according to the embodiment, the temperature sensor 5 is configured to be in direct contact with the battery case 2 (inner surface 222a of the side plate portion 222). This allows for high-precision estimation of the temperature of the sealing material 4 in the battery pack 1 and prevents impairment of the sealing function of the sealing material 4. This structure enables the temperature of the sealing material 4 to be measured and estimated with high precision by the temperature sensor 5 via the highly thermally conductive battery case 2 (made of a metal material such as iron or aluminum). Note that the temperature sensor 5 is not limited to being positioned adjacent to the case joint portion 200 and in contact with the inner surface 222a of the side plate portion 222 of the lower case 22, provided it is positioned adjacent to the case joint portion 200 and in contact with the inner surface of the battery case 2. For example, the temperature sensor 5 may be positioned adjacent to the case joint portion 200 and in contact with the inner surface of the side plate portion 212 of the upper case 21.

FIG. 2 is a flowchart illustrating an example of overheating suppression control for the sealing material 4 in the battery pack 1 according to the embodiment.

First, the control device estimates the seal material temperature of the battery case 2 based on the measured value from the temperature sensor 5 (Step S1). Next, the control device determines whether the estimated seal material temperature is below a preset allowable value (Step S2). If the control device determines that the estimated seal material temperature is below the preset allowable value (Yes in step S2), it returns from the control sequence. On the other hand, if the control device determines that the estimated seal material temperature is not below the preset allowable value (No in step S2), it implements control capable of reducing the seal material temperature (step S3). The control that the control device implements to reduce the seal material temperature includes, for example, controlling to reduce engine output. After implementing the control to reduce the seal material temperature, the control device returns the series of controls.

In the battery pack 1 according to the embodiment described above, it is possible to suppress the sealing material 4 from becoming excessively hot (overheating) while ensuring that the sealing function of the sealing material 4 is not impaired.

The battery pack according to the present disclosure achieves the effect of being able to estimate the temperature of the sealing material while ensuring that the sealing function of the sealing material is not impaired.

Although the disclosure has been described with respect to the specific embodiment for a complete and clear disclosure, the appended claims are not to be thus limited but are to be construed as embodying all modifications and alternative constructions that may occur to one skilled in the art that fairly fall within the basic teaching herein set forth.

What is claimed is:

1. A battery pack comprising:
a battery case including an upper case and a lower case;
a secondary battery housed in the battery case;
a sealing material disposed between a peripheral portion of the upper case and a peripheral portion of the lower case;
a case joint portion where the peripheral portion of the upper case and the peripheral portion of the lower case are joined via the sealing material; and
a temperature sensor positioned adjacent to the case joint and in contact with an inner surface of the battery case.

2. A battery pack according to claim 1, further comprising an estimation unit configured to estimate a temperature of the sealing material based on a measured value of the temperature sensor.
